(19) United States
(12) Patent Application Publication
(10) Pub. No.: US 2021/0100641 A1
(43) Pub. Date: Apr. 8, 2021

(54) CT Scanning of Impressions with Higher Radiodensity Material

(71) Applicant: James R. Glidewell Dental Ceramics, Inc., Newport Beach, CA (US)

(72) Inventors: Sergey Nikolskiy, Coto de Caza, CA (US); Fedor Chelnokov, Khimki (RU)

(21) Appl. No.: 16/594,479

(22) Filed: Oct. 7, 2019

(51) Int. Cl. A61C 9/00

(52) U.S. Cl. CPC A61C 9/006; A61C 9/0006

(57) ABSTRACT

A method of CT scanning a physical dental impression includes arranging a physical dental impression with a higher radiodensity material in a CT scanner.

### BACKGROUND

Dental prostheses are typically manufactured at specialized dental laboratories that employ computer-aided design (CAD) and computer-aided manufacturing (CAM) milling systems to produce dental prostheses according to patient-specific specifications provided by dentists. In a typical work flow, information about the oral situation of a patient is received from a dentist, the dental laboratory designs the dental prosthesis, and the prosthesis is manufactured using a mill or other fabrication system. When making use of CAD design and CAM manufacturing in dentistry, a digital model of the patient's dentition is required as an input to the process. One technique to generate a digital model includes CT scanning physical dental impressions. Physical dental impressions can include, for example, a rigid frame, handle region, impression material, and mesh. The physical dental impressions can also additionally include a higher radiodensity material arranged in the rigid frame. The presence of the higher radiodensity material can cause CT reconstruction artifacts in regions between the higher radiodensity material using conventional scanning techniques. Due to these reconstruction artifacts, CT scanning of impressions containing higher radiodensity material such as steel wires is typically avoided. Where some conventional techniques attempt to preprocess x-ray projections to eliminate the higher radiodensity material, the techniques can increase CT reconstruction time and still leave artifacts that distort digital model dental regions.

### SUMMARY

Disclosed is a method of CT scanning a physical dental impression. The method can include arranging a physical dental impression comprising a higher radiodensity material in a CT scanner so that a transverse axis of the physical dental impression is non-perpendicular with respect to an axis of rotation.

Also disclosed is a method of CT scanning a physical dental impression that includes arranging a physical dental impression comprising a higher radiodensity material so that the transverse axis is non-parallel with respect to the one or more x-ray paths at any given position around an axis of rotation.

### BRIEF DESCRIPTION OF THE DRAWINGS

FIG. 1 is a perspective view of a three-way dental impression tray.

FIG. 2 is a cross-sectional view of a three-way dental impression tray containing impression material.

FIG. 3 is a schematic diagram of a computed tomography (CT) scanning system.

FIG. 4 is a 2-dimensional (2D) radiographic image of a dental impression tray containing a dental impression.

FIG. 5 is a cross-section of a 3-dimensional (3D) volumetric image.

FIG. 6(a) is a perspective view illustration of a three-way dental impression tray.

FIG. 6(b) is a perspective view illustration of a physical dental impression.

FIG. 7 is an image illustrating a higher radiodensity material arranged in a physical dental impression.

FIG. 8 is a schematic diagram showing a side view of a physical dental impression and holding device in some embodiments.

FIG. 9 is a schematic diagram showing a 2D side view of a physical dental impression as conventionally oriented during scanning.

FIG. 10 is a schematic diagram showing a 2D side view of a conventionally oriented physical dental impression in a computed tomography (CT) scanning system.

FIG. 11 is a 2D image of a CT scanned physical dental impression marked to illustrate intersection of a higher radiodensity material with one or more x-ray paths.

FIG. 12 illustrates a CT reconstructed image showing marked to illustrate effects of multiple intersection points between a higher radiodensity material and one or more x-ray paths.

FIG. 13 illustrates a CT reconstructed image showing reconstruction artifacts.

FIG. 14 illustrates a CT reconstructed image showing reconstruction artifacts.

FIG. 15 illustrates a CT reconstructed image showing at least one region affected by reconstruction artifacts.

FIG. 16 illustrates a CT reconstructed image showing only one intersection point and no reconstruction artifacts.

FIG. 17 illustrates a CT reconstructed image showing only one intersection point and no reconstruction artifacts.

FIG. 18 is a schematic diagram showing a 2D side view of a computed tomography (CT) scanning system having an angled physical dental impression in some embodiments.

FIG. 19 is a schematic diagram showing a 2D side view of a computed tomography (CT) scanning system having an angled physical dental impression in some embodiments.

FIGS. 20 and 21 illustrate CT scan projections of the physical dental impression in some embodiments.

FIG. 22 is a schematic diagram showing a top view of the physical dental impression and a U-shaped portion in some embodiments.

FIG. 23 illustrates a CT scan projection of the physical dental impression with a longer side of the U-shaped portion above a shorter side of the U-shaped portion.

FIG. 24 illustrates a CT scan projection the physical dental impression with the shorter side of the U-shaped portion above the longer side of the U-shaped portion.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

As noted above, in a typical work flow, information about the oral situation of a patient is received from a dentist, the dental laboratory designs the dental prosthesis, and the prosthesis is manufactured using a mill or other fabrication system. When making use of CAD design and CAM manufacturing in dentistry, a digital model of the patient's dentition is required as an input to the process. Despite the rise of intraoral scanning technology, the prevalent method of acquisition of digital model data is still scanning a stone model cast from a physical negative impression of the patient's dentition.

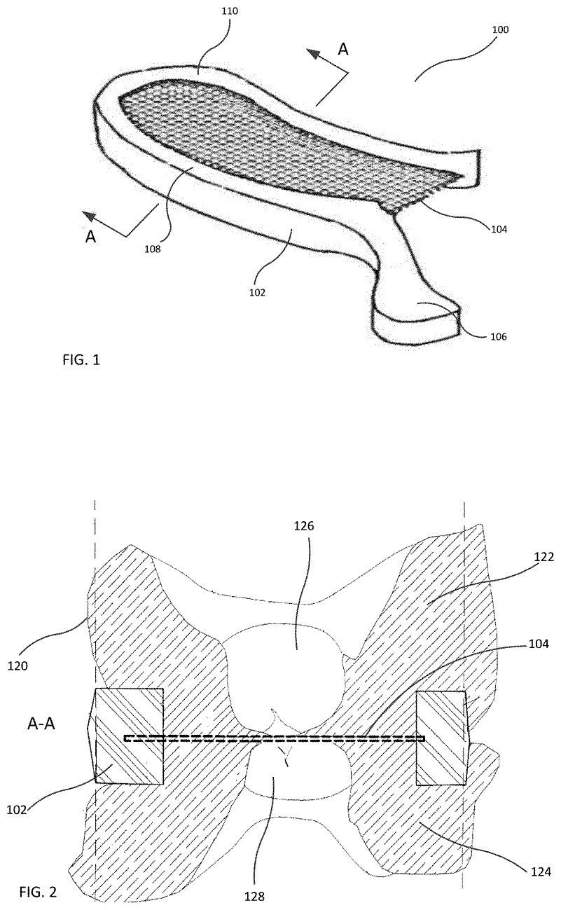

A physical negative impression of the patient's dentition is typically obtained by the use of a dental impression tray containing impression material. An example of an impression tray is shown in FIG. 1 in the form of a three-way impression tray or “triple tray” 100. The triple tray 100 includes a generally rigid frame 102 within which a mesh 104 is retained. The rigid frame defines a handle 106 configured to be gripped by the user, a buccal side wall 108, and a lingual side wall 110. In use, impression material is loaded onto the upper and lower surfaces of the mesh 104 by the clinician. The triple tray 100 is then inserted into the mouth of a patient and the patient is instructed to bite down onto the triple tray 100 and impression material, causing the impression material to conform to the patient's dentition as the impression material cures. Because the triple tray 100 is situated between the upper and lower jaws of the patient, the impression obtained via the triple tray 100 includes information about the dental situation of the patient's upper jaw, lower jaw, and bite registration in the area of the patient's dentition covered by the triple tray.

For example, in FIG. 2, there is shown a sectional view of the triple tray 100 containing impression material 120 after the taking of a physical impression of a patient. An upper impression 122 is formed on the upper side of the mesh 104, and a lower impression 124 is formed on the lower side of the mesh 104. As noted above, after deformation, the impression material 122 defines a physical negative impression of the patient's dentition. Accordingly, the upper void space 126 defined by the upper impression 122 defines the space occupied by the patient's teeth and gingiva in the patient's upper jaw, and the lower void space 128 defined by the lower impression 124 defines the space occupied by the patient's teeth and gingiva in the patient's lower jaw. Moreover, the location and orientation of the upper void space 126 relative to the lower void space 128 defines the bite registration of the patient's dentition in the subject area, including the occlusal spacing and registration.

As noted above, in a conventional workflow, a physical dental impression formed in the manner described above would be used to cast a model of the patient's dentition formed of stone, polymeric, or other suitable material. The cast model would then be scanned using a laser scanner in order to obtain a digital model. The digital model would then be used to design one or more restorations, or for other purposes. This conventional workflow creates potential sources of error or inaccuracy that would be avoided by alternative methods or alternative workflows that avoided the step of forming the case model and, instead, proceeded directly from the physical impression to a digital model.

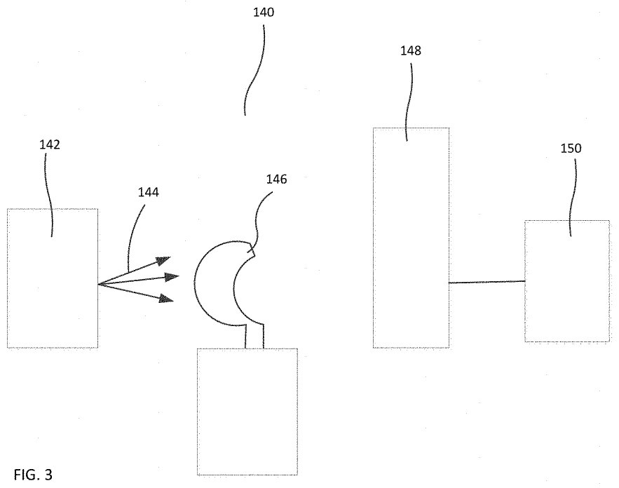

In one embodiment of the present method, a computed tomography (CT) scanner uses x-rays to make a detailed image of a physical impression. A plurality of such images are then combined to form a 3D model of the patient's dentition. A schematic diagram of an example of a CT scanning system 140 is shown in FIG. 3. The CT scanning system 140 includes a source of x-ray radiation 142 that emits an x-ray beam 144. An object being scanned—in the present case, a triple tray containing a physical impression 146—is placed between the source 142 and an x-ray detector 148. The x-ray detector 148, in turn, is connected to a processor 150 that is configured to receive the information from the detector 148 and to convert the information into a digital image file. Those skilled in the art will recognize that the processor 150 may comprise one or more computers that may be directly connected to the detector, wirelessly connected, connected via a network, or otherwise in direct or indirect communication with the detector 148.

An example of a suitable scanning system 140 includes a Nikon Model XTH 255 CT Scanner (Metrology) which is commercially available from Nikon Corporation. The example scanning system includes a 225 kV microfocus x-ray source with a 3 μm focal spot size to provide high performance image acquisition and volume processing. The processor 150 may include a storage medium that is configured with instructions to manage the data collected by the scanning system. A particular scanning system is described for illustrative purposes; any type/brand of CT scanning system can be utilized.

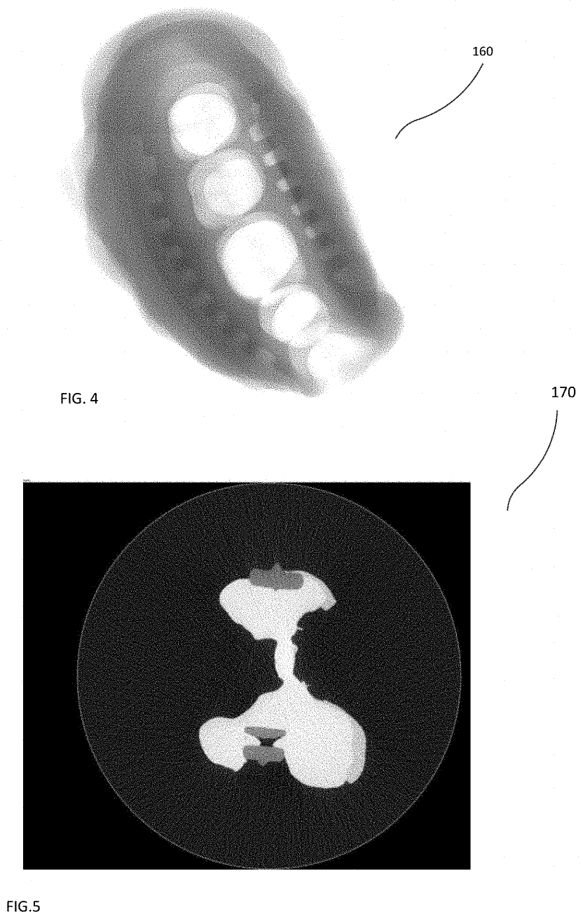

One example of CT scanning is described in U.S. Patent Application No. US20180132982A1 to Nikolskiy et al., which is hereby incorporated in its entirety by reference. As noted above, during operation of the scanning system 140, the impression 146 is located between the x-ray source 142 and the x-ray detector 148. A series of images of the impression 146 are collected by the processor 150 as the impression 146 is rotated in place between the source 142 and the detector 146. An example of a single image 160 is shown in FIG. 4. Each image can represent a cross section of a single horizontal slice of the impression, for example. The image 160 may be a radiograph, a projection, or other form of digital image. In one embodiment, a series of 720 images are collected as the impression 146 is rotated in place between the source 142 and the detector 148. In other embodiments, more images or fewer images may be collected as will be understood by those skilled in the art.

The plurality of images 160 of the impression 146 are generated by and stored within a storage medium contained within the processor 150 of the scanning system 140, where they may be used by software contained within the processor to perform additional operations. For example, in an embodiment, the plurality of images 160 undergo tomographic reconstruction in order to generate a 3D virtual image 170 (see FIG. 5) from the plurality of 2D images 160 generated by the scanning system 140. In the embodiment shown in FIG. 5, the 3D virtual image 170 is in the form of a volumetric image or volumetric density file (shown in cross-section in FIG. 5) that is generated from the plurality of radiographs 160 by way of a reconstruction algorithm associated with the scanning system 140.

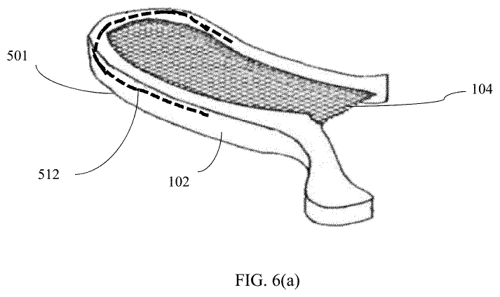

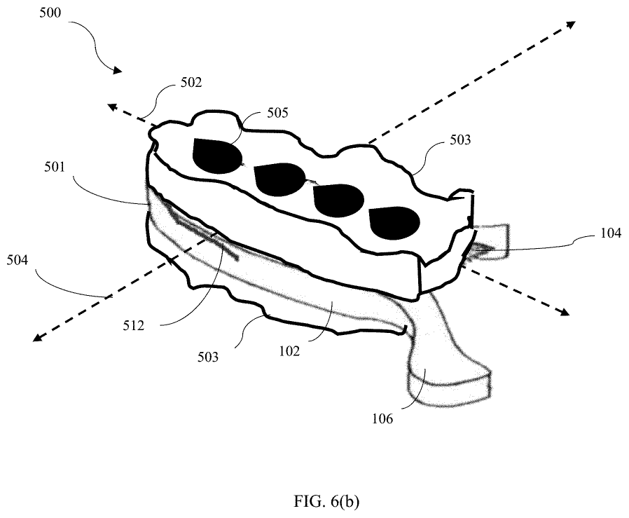

In some embodiments, an impression such as a triple tray impression or any other type of impression can contain material having a higher radiodensity material that can cause distortions after CT reconstruction. FIG. 6(a) illustrates a physical dental impression tray 501 (such as triple tray 100, for example) with a rigid frame 102 and a higher radiodensity material 512 that can be inside the rigid frame 102 and mesh 104. The higher radiodensity material 512 can be a continuous piece of material in some embodiments. In some embodiments, the higher radiodensity material 512 can be in two or more segments. In some embodiments, the higher radiodensity material 512 can be a wire, for example. Although a triple tray is discussed, any type of physical dental tray can be used. The higher radiodensity material 512 can in some embodiments be embedded inside the physical dental impression tray 501 as illustrated in FIG. 6(a). In some embodiments, the higher radiodensity material 512 can be attached along an outside portion of the physical dental impression tray 501. In some embodiments, the higher radiodensity material 512 can be partially inside the rigid frame 102 and partially outside the rigid frame 102. The higher radiodensity material 512 can be arranged in other locations and positions in and/or on the surface of the rigid frame 102 of the physical dental impression tray 501. In some embodiments, the higher radiodensity material 512 can be U-shaped and arranged in or on a U-shaped portion of the physical dental impression tray 501, for example.

Disclosed is a method of CT scanning a physical dental impression that can include arranging a physical dental impression having a higher radiodensity material in a CT scanner to minimize x-rays intersecting the higher radiodensity material more than once in some embodiments. A method of CT scanning a physical dental impression can include arranging a physical dental impression having a higher radiodensity material in a CT scanner so that a transverse axis of the physical dental impression is non-perpendicular with respect to an axis of rotation in some embodiments. A method of CT scanning a physical dental impression, can include arranging a physical dental impression having a higher radiodensity material so that the transverse axis is non-parallel with respect to the one or more x-ray paths at any given position around an axis of rotation in some embodiments. In some embodiments, the physical dental impression can be a triple-tray impression. Other types of physical dental impressions can be used as well.

FIG. 6(b) illustrates one example of a physical dental impression 500 can include the physical dental impression tray 501 with impression material 503 and one or more dentition regions 505. Additional dentition regions are possible and may not be visible in the figure. The physical dental impression 500 can have a longitudinal axis 502 which extends along a length of the physical dental impression 500 and a transverse axis 504 which extends anywhere along a width of the physical dental impression 500. The longitudinal axis 502 and the transverse axis 504 are shown in the figure and throughout other figures at a particular location for illustrative purposes only; they can be located in other positions in some embodiments. The physical dental impression 500 can include, for example, rigid frame 102, handle 106, and mesh 104. The physical dental impression 500 can also include a higher radiodensity material 512.

Radiodensity indicates a material's opacity to x-rays. In some embodiments, radiodensity can be quantified according to the Hounsfield scale and expressed in Hounsfield Units (HU). For example, distilled water can have a radiodensity of 0 HU, and air can have a radiodensity of −1000 HU. In some embodiments, the higher radiodensity material 512 can include one or more materials having a radiodensity of +5,000 HU and above, for example. Some materials having a radiodensity of at least +5,000 HU can include, for example, steel, copper, silver, gold, and/or brass. In some embodiments, the steel can be stainless steel. In some embodiments, the higher radiodensity material 512 can include dental cement, whole/pieces of dental restoration parts such as whole or parts of crowns and/or other dental restoration parts. In some embodiments, the higher radiodensity material 512 can include dental cement, for example. In some embodiments, the rigid frame 102 itself can be made partly or entirely of higher radiodensity material. In some embodiments, the handle 106 can also be partly or entirely out of a higher radiodensity material. For example, in some embodiments, the rigid frame 102 itself can be made partly or entirely out of steel and/or other materials having a radiodensity of at least +5,000HU. In some embodiments, the handle 106 can also be partly or entirely out of steel and/or other materials having a radiodensity of at least +5,000 HU. Other materials having a radiodensity of at least +5,000 HU can be determined by those skilled in the art.

Rigid frame 102, handle 106, and mesh 104 can be made of any material, such as, for example, plastic material. The impression material 503 can be made of any suitable impression material including but not limited to polyvinyl siloxane (pvs), alginate, etc. The higher radiodensity material 512 can be made of material having a greater radiodensity than the impression material 503 in some embodiments. In some embodiments, the higher radiodensity material 512 can have a greater radiodensity than the rigid frame 102, handle 106, and/or the mesh 104. In some embodiments, the impression material 503, rigid frame 102, handle 106, and/or mesh 104 can have radiodensities below +5,000 HU. In some embodiments, the higher radiodensity material 512 can be at least one wire, for example. In some embodiments, the higher radiodensity material 512 can include metal with a radiodensity of at least +5,000 HU, for example, or other any other higher radiodensity material having a radiodensity of at least +5,000 HU.

FIGS. 6(a) and 6(b) illustrate an arrangement of the higher radiodensity material 512 in the rigid frame 102; other arrangements of the higher radiodensity material 512 in other location(s) and/or orientation(s)/configuration(s) in the physical dental impression tray 501 are also possible in some embodiments. The higher radiodensity material 512 can be a single continuous piece, or multiple pieces arranged in different locations of the physical dental impression 500 in some embodiments, for example. Although a triple-tray physical dental impression is discussed for illustrative purposes, any type of physical dental impression having higher radiodensity material can be used.

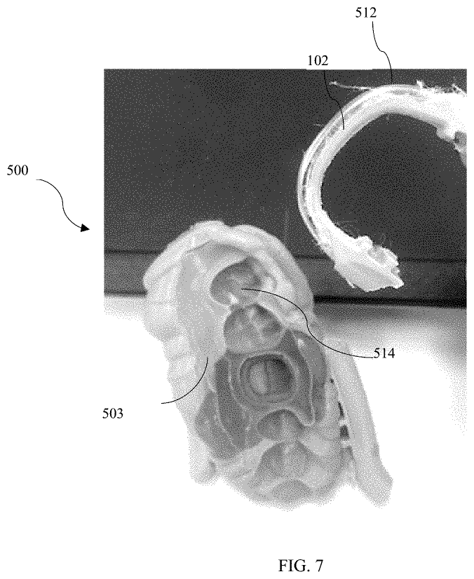

FIG. 7 illustrates the physical dental impression 500 cut apart to show the higher radiodensity material 512 inside a portion of the rigid frame 102 for example. The higher radiodensity material 512 can be arranged to provide support and rigidity for the physical dental impression 500. This arrangement can cause the higher radiodensity material 512 to surround part or all of the dental features 514 in the impression material 503 in some embodiments, for example. In some embodiments, the higher radiodensity material 512 can include a metal with a radiodensity of at least +5,000 HU, for example. In some embodiments, the metal can include steel, for example. Other types of higher radiodensity materials with a radiodensity of at least +5,000 HU can be used.

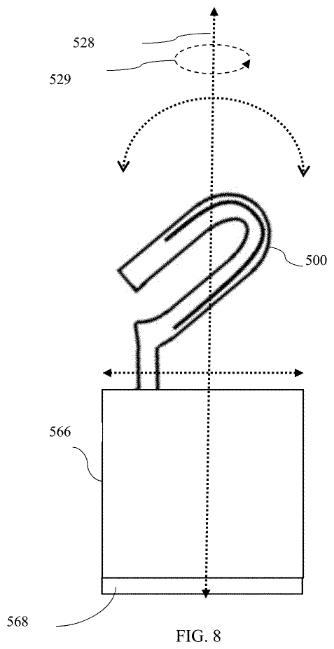

In some embodiments, arranging the physical dental impression includes arranging the physical dental impression 500 between an x-ray source 142 and an x-ray detector 148. This can expose the physical dental impression 500 to x-rays generated by the x-ray source 142. The physical dental impression 500 can be attached to a holding device 566 as illustrated in the example of FIG. 8. In some embodiments, the holding device 566 can include a spring loaded clamp to hold the physical dental impression 500 in a particular arrangement and orientation by clamping together a first and second side of the clamp. As illustrated in FIG. 8, the physical dental impression 500 can be held anywhere along the holding device 566 and moved and re-oriented. In the example of the clamp, the physical dental impression 500 can be moved and re-oriented by releasing the clamp and pivoting or moving the physical dental impression 500 to a desired location/orientation for example. The physical dental impression 500 can be released from the holding device 566. In the example of the clamp, the physical dental impression 500 can be released by applying pressure on either side of the spring loaded clamp to open the clamp, for example. This can release the physical dental impression 500 to be removed, re-arranged, or re-oriented as desired. The holding device 566 can hold the physical dental impression 500 at any location on the physical dental impression 500. For example, in some embodiments, the holding device 566 can removably connect to the physical dental impression 500 at the handle 106. In some embodiments, the holding device 566 can be a shapeable material such as clay or a putty whose shape can conform to adapt to the shape of the region of the physical dental impression 500 to which it connects. The physical dental impression 500 can be connected to the shapeable material in any orientation/arrangement. Although a particular example of the holding device 566 is described, any other type of device capable of holding the physical dental impression 500 can be used, and the physical dental impression can be positioned in additional orientations than those illustrated in FIG. 8.

In some embodiments, the holding device 566 can connect with the handle 106 of the physical dental impression 500 to hold the physical dental impression 500 at a particular arrangement and orientation. However, the holding device 566 can hold the physical dental impression 500 on any suitable region of the physical dental impression 500. The holding device 566 with the physical dental impression 500 can be placed on the rotating platform 568. The x-ray source 142 can optionally be placed or mounted to an optional stand 562. Rotating platform 568 can rotate either clockwise or counterclockwise. The optional stand 562 and rotating platform 568 can be on a CT scanner base 564 in some embodiments, for example. Once scanning is complete, the holding device 566 with the physical dental impression 500 can be removed from the rotating platform 568 and/or the physical dental impression 500 can be removed from the holding device 566 in some embodiments for example. These elements can be configured in other arrangements, and are shown as configured for illustrative purposes.

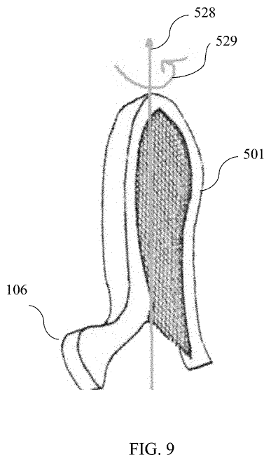

Conventionally, the physical dental impression tray 501 with impression material and one or more dentition regions (impression material and dentition regions not shown for clarity) is scanned so that the longitudinal axis 502 is upright or vertical toward an axis of rotation 528 as illustrated in FIG. 9. The physical dental impression 500 can be rotated in a rotation direction 529. The rotation direction 529 can be clockwise or counterclockwise. In such a conventional arrangement, the axis of rotation 528 is typically longitudinal, for example.

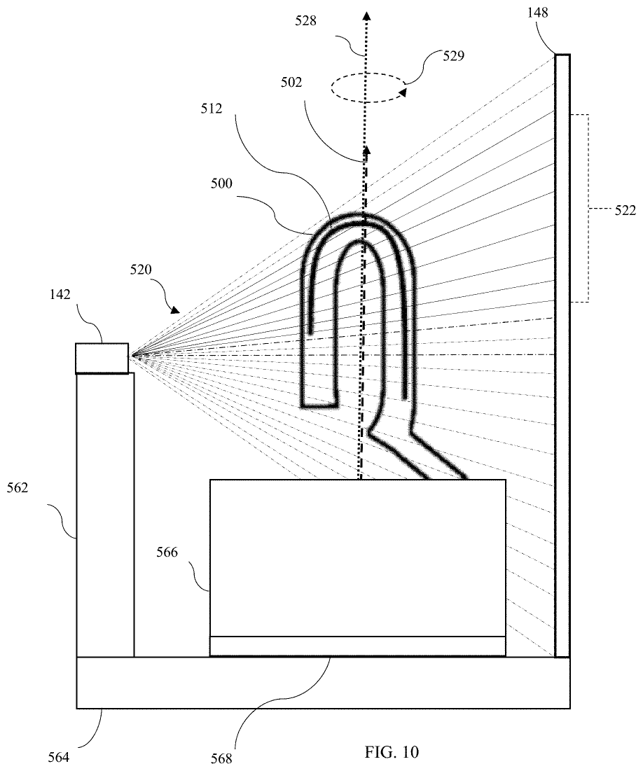

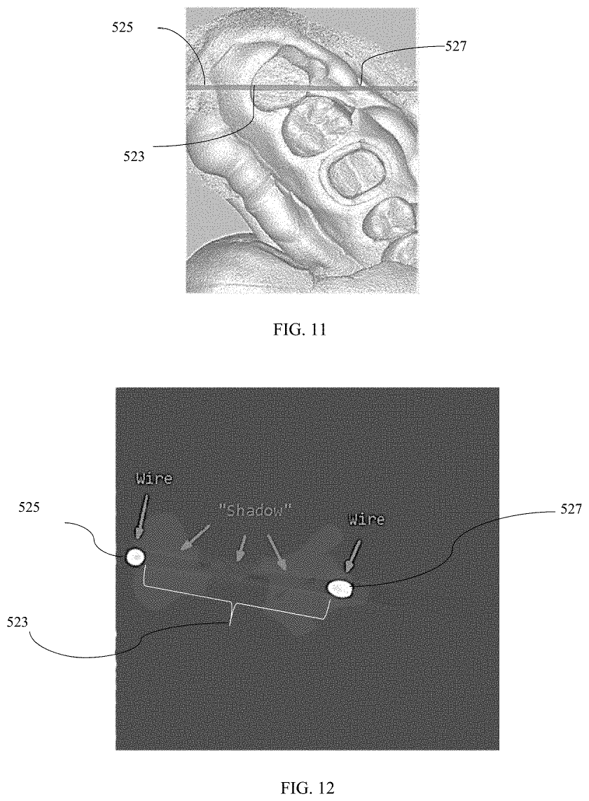

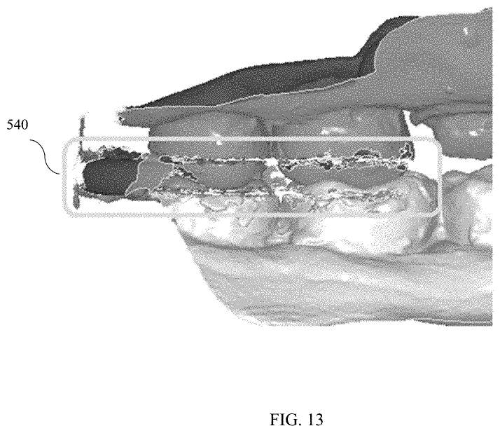

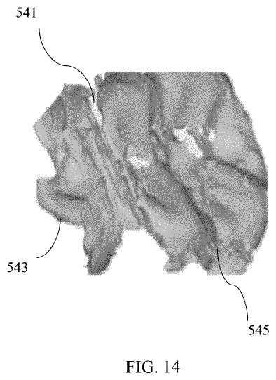

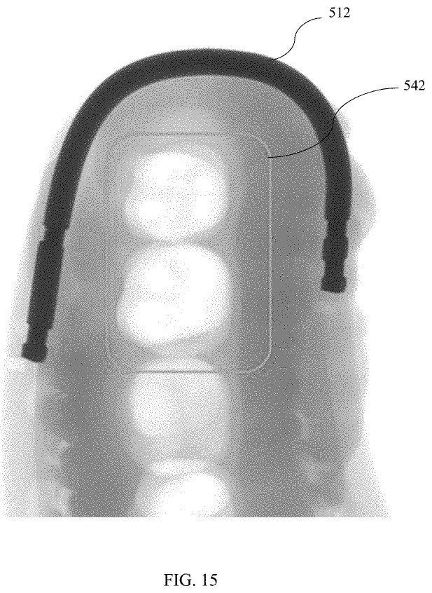

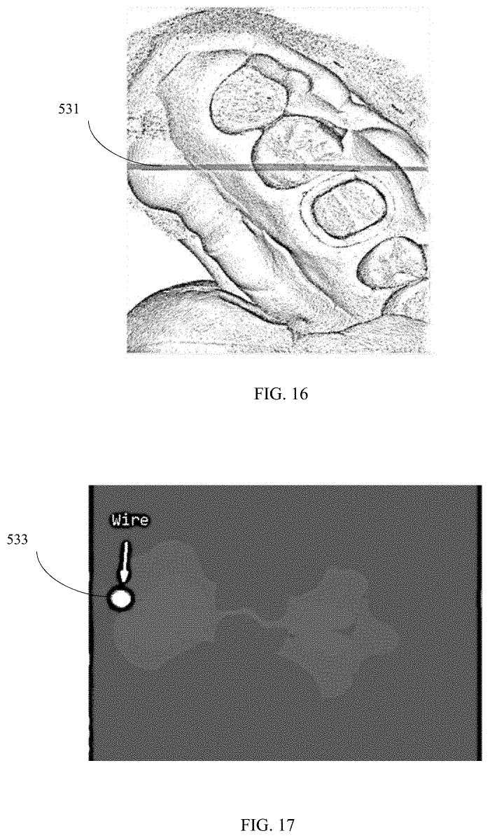

FIG. 10 illustrates an example of CT scanning of a conventionally oriented physical dental impression 500 having a higher radiodensity material 512. For clarity, the mesh and the impression material are not shown in the figure. The physical dental impression 500 can, in some embodiments, include impression material arranged at least as previously described. The physical dental impression 500 can also include the mesh as previously described in some embodiments. Arrangement between the x-ray source 142 and x-ray detector 148 exposes the physical dental impression 500 and the higher radiodensity material 512 to one or more x-rays along one or more x-ray paths 520. Exposure to the one or more x-ray paths 520 can generate one or more horizontal slices during CT reconstruction in some embodiments, for example. The one or more x-ray paths 520 shown in this and other figures is for illustrative purposes only; the number of x-ray paths 520 can be more or less. The one or more x-ray paths 520 can extend from the x-ray source 524 to the x-ray detector 148 in some embodiments, for example. In some embodiments, the one or more x-ray paths 520 are those that extend from the x-ray source 524 to the x-ray detector 148 and pass through the physical dental impression 500, for example. X-rays can travel along the one or more x-ray paths 520. In some embodiments, the one or more x-ray paths 520 can together be in a conical shape, for example, such as the one illustrated in FIG. 10. In the conventional arrangement, the longitudinal axis 502 is typically arranged vertically, in a direction of the axis of rotation 528, and not directed along the one or more x-ray paths 520 at any position when the physical dental impression 500 is rotated around the axis of rotation 528. In the conventional arrangement, the one or more x-ray paths 520 intersect with the higher radiodensity material 512 in multiple locations in at least one rotational position when the physical dental impression 500 is rotated about the axis of rotation 528. In some embodiments, the physical dental impression 500 is rotated relative to the x-ray source 142 and/or x-ray detector 148, and the one or more x-rays traveling along the one or more x-ray paths 520 can intersect with the higher radiodensity material 512 in multiple locations in at least one position during rotation. For example, the one or more x-ray paths in region 522 intersect the higher radiodensity material 512 in multiple locations (twice) at the rotational position illustrated in the figure. FIG. 11 illustrates an example of one x-ray path 523 intersecting the higher radiodensity material in first and second intersection points 525 and 527. FIG. 12 illustrates a cross section of the reconstructed volume generated by one or more x-rays traveling along the x-ray path 523 with the first and second intersection points 525 and 527 with the higher radiodensity material. Intersection with the first and second intersection points 525 and 527 along the x-ray path 523 can cause a shadow in the image generated by the one or more x-rays traveling along the x-ray path 523, which can distort the CT reconstruction of the area between the first and second intersection points 525 and 527, for example. Intersection with the higher radiodensity material 512 by the x-rays travelling along the one or more x-ray paths 520 in more than one location (multiple locations) at one or more rotational positions can cause the severe reconstruction artifacts 540, 541, 543, and 545 illustrated in FIGS. 13 and 14. For example, as illustrated in FIG. 15, the reconstruction artifacts caused by the one or more x-rays intersecting the higher radiodensity material 512 more than once can severely distort CT reconstruction of dentition regions 542. As illustrated in FIG. 16 and FIG. 17, on the other hand, an x-ray path 531 intersecting the higher radiodensity material at only single intersection point 533 does not produce a shadow artifact.

In some embodiments, the physical dental impression 500 can be arranged to minimize reconstruction artifacts. For example, the physical dental impression 500 can be arranged to minimize the number of intersection points between one or more x-rays or one or more x-ray paths and the higher radiodensity material 512. In some embodiments, physical dental impression 500 can be arranged to minimize the number of multiple intersection points between one or more x-rays or one or more x-ray paths and the higher radiodensity material 512. In some embodiments, the physical dental impression 500 with the higher radiodensity material 512 can be arranged in a CT scanner to minimize x-rays or x-ray paths intersecting the higher radiodensity material more than once. In some embodiments, the physical dental impression 500 can be arranged in a CT scanner to be angled with respect to the axis of rotation 528 to minimize intersection points between the higher radiodensity material and one or more x-ray paths 520.

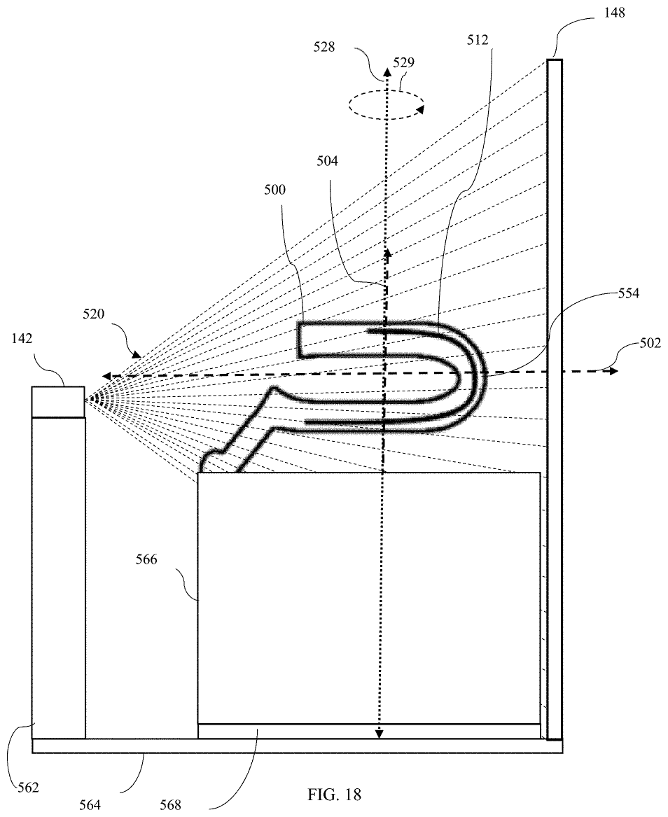

FIG. 18 illustrates one embodiment in which the physical dental impression 500 is arranged to minimize reconstruction artifacts by angling the physical dental impression 500 during scanning. For clarity, the mesh and the impression material are not shown in the figure. The physical dental impression 500 can, however, include impression material arranged at least as described previously in some embodiments. The physical dental impression 500 can also include the mesh as described previously in some embodiments. As illustrated in the figure, the transverse axis 504 of the physical dental impression 500 can be arranged to be oriented at an angle with respect to the one or more x-ray paths 520 at any given position around an axis of rotation 528, for example. In some embodiments, the physical dental impression 500 is arranged so that the transverse axis 504 is non-parallel with respect to the one or more x-ray paths 520 at any given position around an axis of rotation 528. As illustrated in FIG. 18, the transverse axis 504 can be arranged to be angled and/or non-parallel with respect to the one or more x-ray paths 520 by initially arranging the physical dental impression 500 so that the longitudinal axis 502 is oriented toward a direction perpendicular to the axis of rotation 528 and/or the transverse axis 504 is oriented toward a direction parallel to the axis of rotation 528. In some embodiments, non-parallel can include an angle between the transverse axis 504 and the one or more x-ray paths 520 that is greater or less than zero degrees.

In some embodiments, the physical dental impression 500 can be arranged in a CT scanner to be angled with respect to the axis of rotation 528 to minimize intersection points between the higher radiodensity material 512 and one or more x-ray paths 520. For example, the transverse axis 504 can be oriented toward a direction parallel to the axis of rotation 528. For example, the physical dental impression 500 can be arranged so that a transverse angle 552 between the transverse axis 504 and the axis of rotation 528 is minimized in some embodiments. In some embodiments, for example, the transverse angle 552 can be reduced as much as possible based on physical/space constraints, obstacles, and/or other scanning limitations that may hinder or prevent the physical dental impression 500 from rotating or the CT scanner from obtaining a scan. In some embodiments, the transverse angle 552 is the angle formed between the portions of the transverse axis 504 and the axis of rotation 528 above their intersection point, or the angle formed between the portions of the axes furthest from rotating platform 568 at any rotational position. The physical dental impression 500 can be arranged so that the transverse axis 504 is non-perpendicular with the axis of rotation 528 in some embodiments. For example, the physical dental impression 500 can be arranged so that the transverse angle 552 is less than 90 degrees in some embodiments. In some embodiments, the transverse angle 552 can be in the range of 0 to less than 90 degrees (including zero degrees). The physical dental impression 500 can be arranged so that the transverse axis 504 is parallel with the axis of rotation 528 in some embodiments. The physical dental impression 500 can be arranged so that the axis of rotation 528 as illustrated in the figure is oriented transversely across the physical dental impression 500. In some embodiments, the physical dental impression 500 can be arranged so that axis of rotation 528 is oriented transversely over roughly a centroid of the physical dental impression 500, or across a dentition region of the physical dental impression 500, for example. However, the physical dental impression 500 can be arranged to have any axis of rotation 528.

In some embodiments, the axis of rotation 528 is not parallel to the one or more x-ray paths 520. In some embodiments, the axis of rotation 528 is perpendicular to at least one of the one or more x-ray paths 520.

In the example illustrated in the figure, the physical dental impression 500 is arranged so that the longitudinal axis 502 is initially oriented toward the detector 148 and/or is approximately orthogonal to the x-ray detector 148. The top region 554 of the physical dental impression 500 can be initially oriented toward the detector, for example. Although the physical dental impression 500 is illustrated in the figure with the longitudinal axis 502 oriented in the horizontal direction from the x-ray source 142 to the detector 148, the longitudinal axis 502 can be initially oriented in any horizontal direction. In some embodiments, the physical dental impression 500 can be arranged such that the longitudinal axis 502 is non-parallel with the axis of rotation 528. In some embodiments, the physical dental impression 500 can be arranged so that the longitudinal axis 502 is perpendicular to the axis of rotation 528.

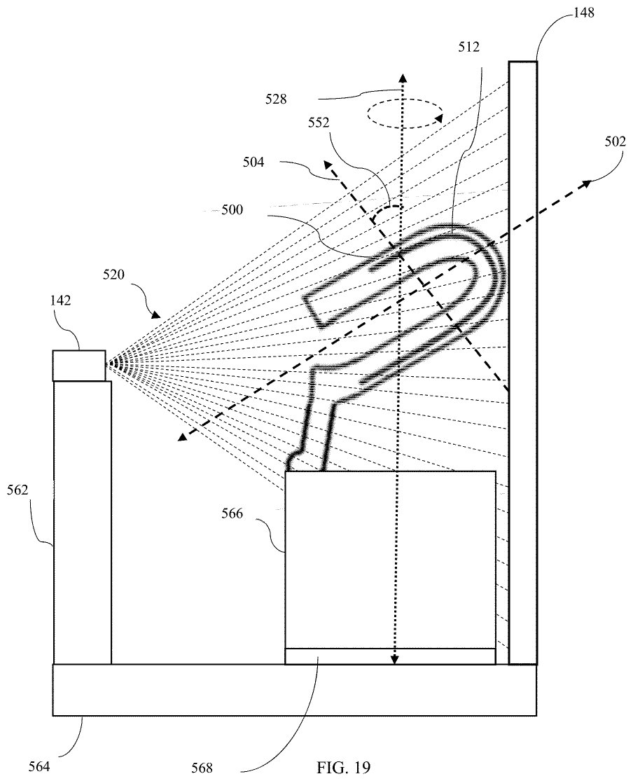

In some instances, it may be challenging to arrange the physical dental impression 500 so that the transverse axis 504 is parallel with the axis of rotation 528. This can be due to space restrictions or obstacles that can impede rotation of the physical dental impression 500 in that arrangement and/or limit scanning. In some embodiments, the physical dental impression 500 can be arranged to minimize reconstruction artifacts by angling the physical dental impression 500 as much as possible during scanning. For example, FIG. 19 illustrates one embodiment in which the transverse axis 504 of the physical dental impression 500 is arranged to be angled with respect to the one or more x-ray paths 520 at any given position around an axis of rotation 528. For clarity, the mesh and the impression material are not shown in the figure. The physical dental impression 500 can, however, include impression material arranged at least as described previously in some embodiments. The physical dental impression 500 can also include the mesh in some embodiments. The physical dental impression 500 can be arranged initially so that a transverse angle 552 between the transverse axis 504 and the axis of rotation 528 is minimized while still allowing clearance for the physical dental impression 500 to rotate about the axis of rotation 528. For example, as illustrated in the figure, the physical dental impression 500 can be arranged so that the longitudinal axis 502 is initially oriented maximally (as much as possible) toward the detector 148 and/or is maximally close to orthogonal to the x-ray detector 148 as possible while still allowing clearance for the physical dental impression 500 to rotate.

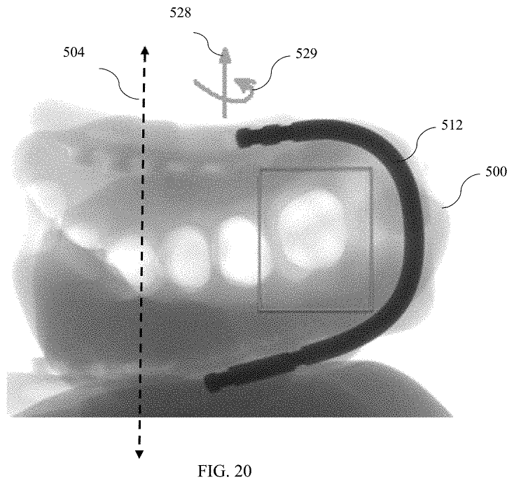

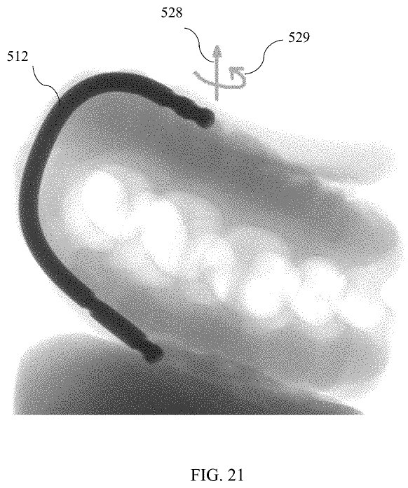

FIGS. 20 and 21 illustrate examples of one embodiment of CT scan projections taken of the physical dental impression 500 arranged with the transverse axis 504 non-perpendicular to the axis of rotation 528. As the physical dental impression 500 is rotated around the axis of rotation 528, the arrangement minimizes the number of x-ray paths intersecting the high radiodensity material 512 in each rotational position such as the two rotational positions shown in FIGS. 20 and 21.

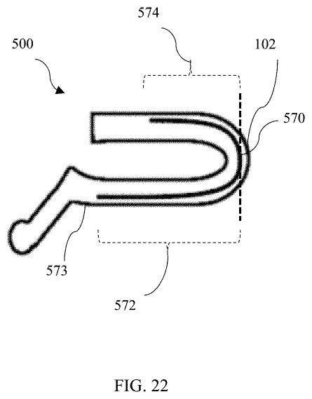

As illustrated in the example of FIG. 22, the higher radiodensity material 512 can include a curved region 570 that can be U-shaped in or on the physical dental impression 500 in some embodiments. The curved region 570 can accommodate the shape of the rigid frame 102, for example. In some embodiments, the higher radiodensity material 512 can have a longer side 572 and a shorter side 574 on either side of the curved region 570. In some embodiments, the longer side 572 can be on the same side of each of a set of physical dental impressions. For example, the longer side 572 can consistently always be on a handle region side 573 for each physical dental impression. This can provide a visual indication of the longer side 572. In some embodiments, the shorter side 574 can consistently always be on a handle region side 573 for each physical dental impression. This can provide an easy visual indication of the shorter side 574. In some embodiments, a first radiograph of the physical dental impression 500 can show the location of the longer side 572 and the shorter side 574. This can be done prior to performing the scan, for example. In some embodiments, other techniques can be used to identify the longer side 572 and the shorter side 574.

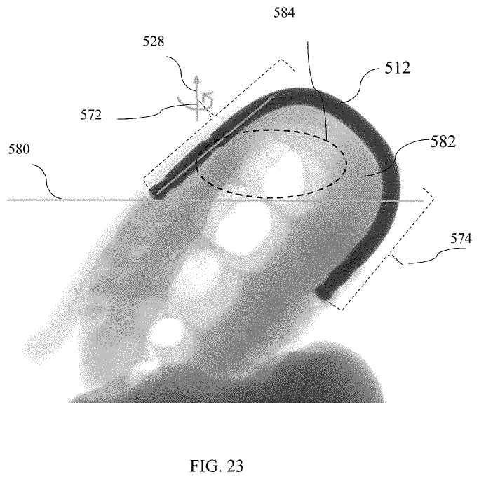

FIG. 23 illustrates one arrangement with the longer side 572 is arranged to be located above the shorter side 574 during scanning. X-ray paths above x-ray path 580 (i.e. distorted region 582 enclosed between the x-ray path 580 and the higher radiodensity material 512) can intersect the higher radiodensity material (upward along the axis of rotation 528) in multiple points. This can cause reconstruction artifacts in the distorted region 582 which can distort images of dentition regions such as dentition region 584, for example.

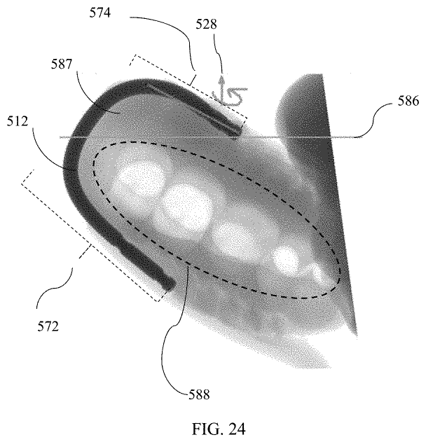

In some embodiments, the physical dental impression 500 can be arranged with the shorter side 574 of the higher radiodensity material 512 above the longer side 572 of the higher radiodensity material 512 to reduce or minimize the number of x-rays or x-ray paths intersecting the higher radiodensity material 512 at multiple points. For example, as illustrated in FIG. 19, arranging the physical dental impression 500 to minimize the number of intersection points between one or more x-ray paths and the higher radiodensity material as described previously along with the shorter side 574 above the longer side 572 (e.g. the shorter side 574 further from the holding device 566 than the longer side 572) can reduce or minimize the number of x-rays or x-ray paths intersecting the higher radiodensity material 512. This can be used in some embodiments where the physical dental impression 500 may be limited in its range of motion due to physical restrictions as described previously, including physical restrictions arising during rotation of the physical dental impression 500 or for any other reason, for example. FIG. 24 illustrates one arrangement with the shorter side 574 is positioned above the longer side 572 during scanning. X-ray paths above x-ray path 586 (i.e. distorted region 587 enclosed between the x-ray path 586 and the higher radiodensity material 512) can intersect the higher radiodensity material (upward along the axis of rotation 528) in multiple points. However, due to the shorter side 574's position above the longer side 572, the distorted region 587 is smaller and may not affect dentition regions 588, for example.

At least one advantage of many of one or more features described in the present disclosure can include for example allowing CT scanning of physical dental impressions with higher radiodensity material, not significantly increasing CT processing time, and removing or reducing artifacts of the higher radiodensity material on reconstructed teeth.

The above descriptions of the scanning system and the algorithms used to perform the scanning, imaging, and reconstruction are not intended to suggest any limitation as to scope of use or functionality. For example, the computing environment used to perform these functions can be any of a variety of computing devices (e.g., desktop computer, laptop computer, server computer, tablet computer, gaming system, mobile device, programmable automation controller, etc.) that can be incorporated into a computing system comprising one or more computing devices.

For example, a computing environment may include one or more processing units and memory. The processing units execute computer-executable instructions. A processing unit can be a central processing unit (CPU), a processor in an application-specific integrated circuit (ASIC), or any other type of processor. In a multi-processing system, multiple processing units execute computer-executable instructions to increase processing power. For example, a representative computing environment may include a central processing unit as well as a graphics processing unit or co-processing unit. The tangible memory may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage, one or more input devices, one or more output devices, and one or more communication connections. An interconnection mechanism such as a bus, controller, or network, interconnects the components of the computing environment. Typically, operating system software provides an operating environment for other software executing in the computing environment, and coordinates activities of the components of the computing environment.

The tangible storage may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

In view of the many possible embodiments to which the principles of the disclosure may be applied, it should be recognized that the illustrated embodiments are only examples and should not be taken as limiting the scope of the disclosure. Rather, the scope of the invention is defined by all that comes within the scope and spirit of the following claims.

What is claimed is:

1. A method of CT scanning a physical dental impression, comprising:
arranging a physical dental impression comprising a higher radiodensity material in a CT scanner so that a transverse axis of the physical dental impression is non-perpendicular with respect to an axis of rotation.

2. The method of claim 1, wherein the transverse axis is parallel to the axis of rotation.

3. The method of claim 1, wherein the higher radiodensity material comprises a wire.

4. The method of claim 3, wherein the higher radiodensity material comprises a steel wire.

5. The method of claim 1, wherein the higher radiodensity material comprises a rigid body of the physical dental impression.

6. The method of claim 1, wherein the higher radiodensity material comprises one or more materials with a radiodensity greater than a radiodensity of an impression material of the physical dental impression.

7. The method of claim 1 wherein the higher radiodensity material has a curved region and a longer side and shorter side on either side of the curved region.

8. The method of claim 7, wherein the physical dental impression is arranged in the CT scanner with the shorter side above the longer side.

9. The method of claim 1, further comprising scanning the physical dental impression in the CT scanner.

10. The method of claim 1, wherein the axis of rotation is not parallel to one or more x-ray paths.

11. The method of claim 10, wherein the axis of rotation is perpendicular to at least one of the one or more x-ray paths.

12. The method of claim 1, wherein a transverse angle between the transverse axis and the axis of rotation is minimized.

13. A method of CT scanning a physical dental impression, comprising:
arranging a physical dental impression comprising a higher radiodensity material so that the transverse axis is non-parallel with respect to the one or more x-ray paths at any given position around an axis of rotation.

14. The method of claim 13, wherein the higher radiodensity material comprises a wire.

15. The method of claim 14, wherein the higher radiodensity material comprises a steel wire.

16. The method of claim 15, wherein the higher radiodensity material has a curved region and a longer side and shorter side on either side of the curved region.

17. The method of claim 16, wherein the physical dental impression is arranged with the shorter side above the longer side.

18. The method of claim 13, further comprising scanning the physical dental impression in the CT scanner.

19. The method of claim 13, wherein the higher radiodensity material comprises a rigid body of the physical dental impression.

20. The method of claim 13, wherein the higher radiodensity material comprises one or more materials with a radiodensity greater than the radiodensity of an impression material of the physical dental impression.
